(19) United States
(12) Patent Application Publication
(10) Pub. No.: US 2009/0115174 A1
(43) Pub. Date: May 7, 2009

(54) Slotted/tapered filter

(75) Inventor: Marcus Clark, Kaysville, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/982,929

(22) Filed: Nov. 6, 2007

(51) Int. Cl. B60R 21/268

(52) U.S. Cl. 280/741

(57) ABSTRACT

An inflator may be constructed having a generant chamber. The chamber houses a quantity of gas generant. A wrapped filter is also added to the inflator. The wrapped filter is positioned proximate the generant chamber. The filter includes an outer edge and an inner edge. The filter is also tapered from the outer edge to the inner edge. A second filter that also has a tapered profile may also be added opposite the first filter.

### BACKGROUND OF THE INVENTION

Airbag inflators are commonly used in airbag systems. The airbag inflator is used to produce or channel a quantity of inflation gas into the airbag. This channeling of gas into the airbag causes the airbag to inflate and become positioned in the interior of the vehicle.

One type of inflator known in the industry is the so-called “pyrotechnic” or gas generating inflator. These inflators comprise a quantity of solid gas generant housed within a chamber. In the event of an accident or crash, the quantity of gas generant is ignited, thereby producing a quantity of inflation gas. This produced inflation gas may then be channeled out of the inflator and used to inflate the airbag.

Pyrotechnic inflators may be used in side impact airbag systems—i.e., systems that are designed to protect a vehicle occupant from harmfully impacting the door or lateral side of the vehicle. The airbags used in a side impact airbag system will be stored proximate the vehicle's roof and will, during inflation, descend to cover the vehicle's window, door and lateral side.

The pyrotechnic inflators that are used in these side impact airbag systems are relatively long and have a thin, slender profile. For example, FIG. 1 is a cross-sectional view of a prior art inflator design. This inflator 10 has shows a chamber 11 that houses gas generant 12. A first and second filter 16, 20 are added to the ends of the chamber 11. There are penings 24 positioned outside each of the filters 16, 20 such that gas will flow out of the chamber 11, through one of the filters 16, 20, and then exit the inflator 10 via the openings 24.

The inflator in FIG. 1 has a long, slender profile. Such long, thin profile is necessary to mount these inflators on or proximate the vehicle's roof or roof rail. However, this type of prior art inflator can have very high internal pressures due to the difficulty of venting the gas quickly. There is a need in the art for a new type of pyrotechnic inflator that is capable of venting the burning gases ore quickly. Such a device is disclosed herein.

### BRIEF SUMMARY OF THE INVENTION

An inflator is disclosed. The inflator comprises a generant chamber housing a quantity of gas generant. The inflator also comprises a wrapped filter positioned proximate the generant chamber, the filter comprising an outer edge and an inner edge, the filter being tapered from the outer edge to the inner edge. In some embodiments, a cutout is added to the outer edge. One or more exit holes may also be added to the inflator. In some embodiments, the exit holes are positioned exterior of the filter, so that the cutout is aligned with the exit holes. The cutout may operate to create a plenum proximate the openings. The tapered filter may have either a straight or a non-straight (for example, stepped) profile.

In other embodiments, a second filter is added to the inflator. The second filter comprises an outer edge and an inner edge, the second filter being tapered from the outer edge to the inner edge. A cutout may also be added to the outer edge of the second filter.

The present embodiments relate to an inflator that may be installed on a vehicle as part of a side impact airbag system. The inflator includes a quantity of gas generant that is housed within a gas generant chamber. The gas generant is designed such that, if ignited, the gas generant will produce a quantity of inflation gas. One or more exit holes may also be added to the inflator. The exit holes are designed such that when the gas is created due to actuation of an initiator or igniter and ignition of the generant, the gas will exit out of the inflator via the exit holes.

A filter may be added to the inflator. The filter may be positioned proximate the chamber. The exit holes are exterior of the filter such that the gas produced by ignition of the gas generant passes through the filter prior to exiting the inflator.

The inflator may be a “dual outlet” inflator. This means that there are multiple sets of exit holes, one set of exit holes positioned proximate the distal end and another set of holes positioned proximate a proximal end of the inflator. Positioned in front of the proximal set of exit holes is a second filter, which may be similar and/or identical to the filter. Thus, when the gas is produced during actuation, the gas may flow either direction out of the chamber and pass through either the filter or the second filter.

The filters are designed such that they may be “wrapped” filters. This means that the filters may be wrapped around a mandrel axis to produce the round, wrapped configuration. The filters may have an inside edge and an outside edge. The filters are tapered from the outer edge to the inner edge. In some embodiments, this tapering will be gradual. In other embodiments, the filter will have non-straight or stepped profile. This stepped profile means that the filter comprises a variety of steps that “descend” from the outer edge to the inner edge.

The filters may also be designed such that a cutout is added to the outer edge. The cutout is an incision or notch in the filter that extends inwardly from the outer edge. The cutout is positioned such that when the filters are wrapped and positioned on the inflator, the position of the cutout corresponds to the position of the openings. In other words, the cutout will be positioned directly inward of the exit hole.

By positioning the cutout directly inward of the opening, a plenum is created between the hole and the filter. This plenum receives the inflation gas that is produced during ignition of the gas generant. The existence of this plenum allows the escaping inflation gas to exit the exit hole more freely.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a cross-sectional view of a prior art inflator;

FIG. 2 is a cross sectional view of an inflator according to the present embodiments; and

FIG. 3 is a plan view that illustrates filters that may be used in the inflator of FIG. 2, wherein the filters are shown in their unwrapped configuration;

FIG. 4 is a plan view that illustrates another embodiment of a filter that may be used in the inflator of FIG. 2, wherein the filter is shown in its unwrapped configuration;

FIG. 5 is a cross-sectional view of the filter of FIG. 4; and

FIGS. 6A and 6B are view of another embodiment of a wrapped filter that may be used herein.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

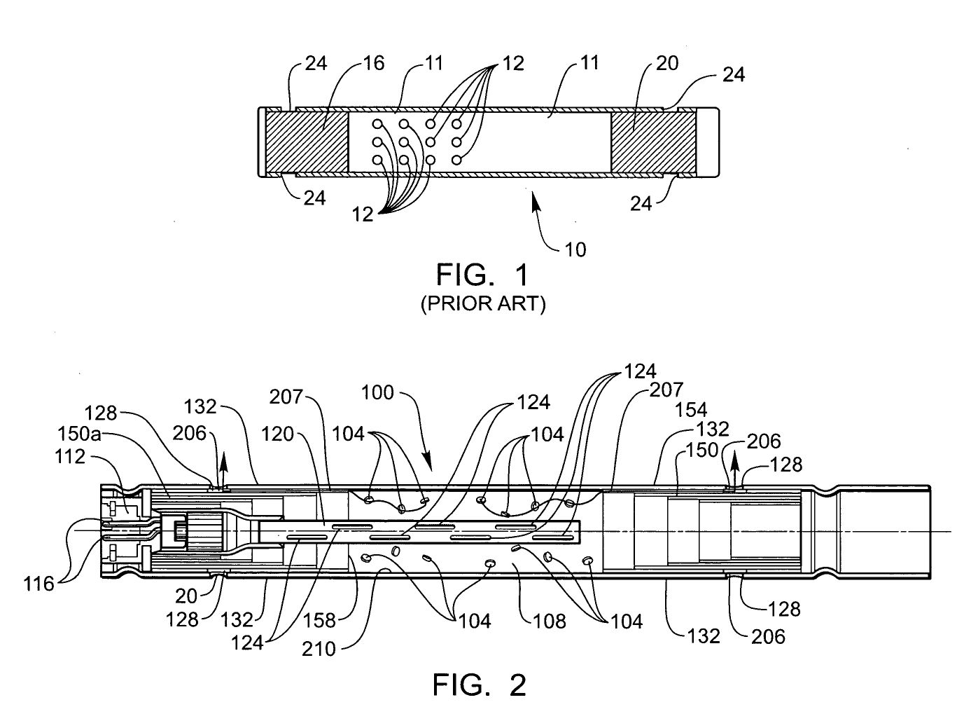

Referring now to FIG. 2, an inflator 100 is illustrated. The inflator 100 may be installed on a vehicle as part of a side impact airbag system. Accordingly, the inflator 100 has a long and slender profile. In the embodiment of FIG. 2, the inflator 100 is generally cylindrical in shape. The exact dimensions of the inflator 100 will depend upon the particular embodiment and the size, model, and type of the vehicle onto which the inflator 100 is used. In some embodiments, the inflator 100 will have an outside diameter of about 20 millimeters. The length of the inflator 100 may be designed such that it is capable of being positioned along the roof or roof rail of a vehicle.

The inflator 100 includes a quantity of gas generant 104 that is housed within a gas generant chamber 108. The amount of the gas generant 104, as well as the size of the chamber 108 that is used to house the gas generant 104, will depend upon the specific embodiment. A variety of different substances and materials may be used as the gas generant 104, as known in the art. In FIG. 2, the gas generant 104 is shown as tablets or pellets. Other shapes, sizes, etc. of the gas generant 104 may be used. The generant 104 may be tightly packed in the chamber 108, or in other embodiments, may be loosely packed. For purposes of clarity, the generant 104 is shown as being loosely packed in the chamber 108.

The gas generant 104 is designed such that, if ignited, the gas generant 104 will produce a quantity of inflation gas. This inflation gas may then be channeled out of the inflator 100 and used to inflate an airbag (not shown).

In order to ignite the gas generant 104, a squib 112 may be used. The squib 112 is an element known in the art and comprises one or more pins 116. In the event of an accident, an electrical charge or current is sent through the pins 116 to the squib 112. This influx of current/charge into the squib 112 will ignite a quantity of generant (not shown) housed within the squib 112 to create a quantity of gas (or hot gas). This gas will then flow through an igniter tube 120, which is positioned, at least partially, within the chamber 108. The igniter tube 120 is positioned proximate the gas generant 104. As required, one or more openings 124 may be positioned on the igniter tube 120. Accordingly, the gas produced by the squib 112 will flow through the igniter tube 120 and exit the igniter tube 120 via the openings 124. When the gas flows out of the igniter tube 120, it contacts and ignites the generant 104 (or the generant bed). As is known in the art, this ignition of the gas generant 104 will produce a large quantity of inflation gas—i.e., a quantity of inflation gas sufficient to inflate an airbag.

It should be noted that the squib 112 and pins 116 are features known in the art and represent one example of the way in which the gas generant 104 may be ignited during actuation. As will be appreciated by those skilled in the art, other features or mechanisms for igniting the gas generant 104 may also be used.

One or more exit holes 128 may also be added to the inflator 100. The exit holes 128 are designed such that when the gas is created due to actuation and ignition of the generant 104, the gas will exit out of the inflator 100 via the exit holes 128. The exit holes 128 are openings that are positioned on the outer surface 132 of the inflator 100.

In some situations, it may desirable to filter the gas produced by ignition of the generant 104, prior to the gas exiting the inflator 100 through the exit holes 128. Such filtering helps to remove any particulates formed during ignition, thereby preventing such particulates from exiting the inflator 100. Filtering the gas may also operate to cool the hot gas that is formed during ignition.

In order to filter the produced gas, a filter 150 may be added to the inflator 100. The filter 150 may be positioned proximate the chamber 108 and may be positioned at a distal end 154 of the inflator 100. The exit holes 128 are exterior of the filter 150 such that the gas produced by ignition of the gas generant 104 passes through the filter 150 prior to exiting the inflator 100 through the exit holes 128.

In the embodiment shown in FIG. 2, the inflator 100 is a “dual outlet” inflator. This means that there are multiple sets of exit holes, one set of holes 128 positioned proximate the distal end 154 and another set of holes 128 positioned proximate a proximal end 158 of the inflator 100. Positioned in front of the proximal set of exit holes 128 is a second filter 150a, which is similar and/or identical to the filter 150. The second filter 150a also operates to cool the inflation gas and prevent particulates from exiting the inflator 100. Thus, when the gas is produced during actuation, the gas may flow either direction out of the chamber 108 and pass through either the filter 150 or the second filter 150a.

The filters 150, 150a may be made of metal, or more particularly, an expanded metal. Of course, other materials may be used for the filter, as desired.

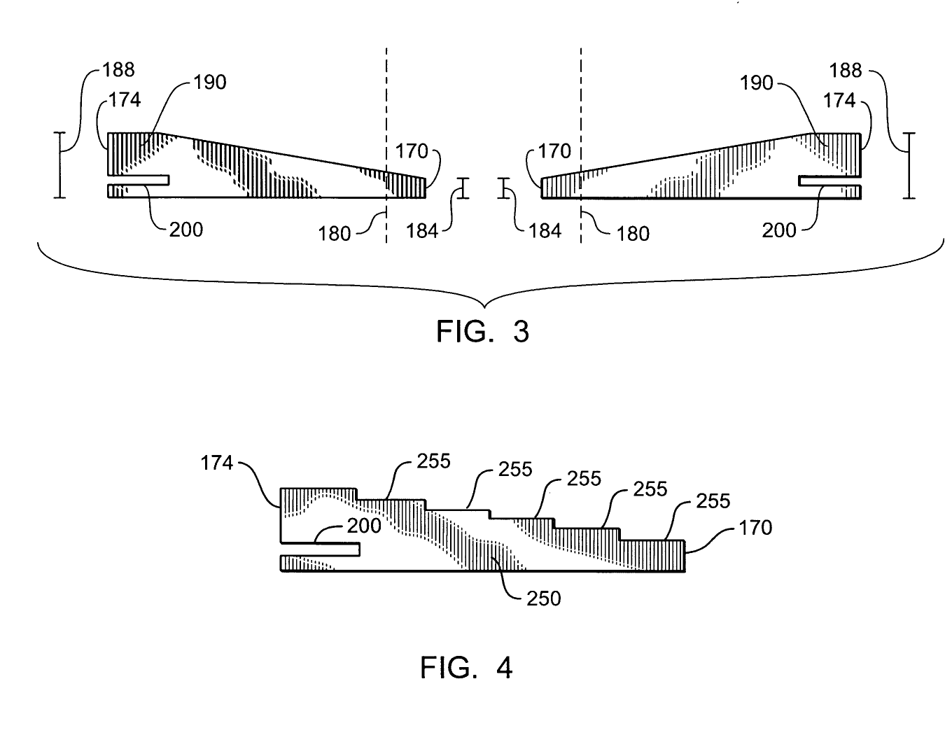

FIG. 3 is an unwrapped, plan view of the filters 150, 150a that shows the filter 150 and the second filter 150a in greater detail. Those skilled in the art will appreciate that the filter 150a may be identical to the filter 150. In other embodiments, the filter 150 may differ from the second filter 150a, as desired. In other embodiments, two filter may be connected to make a single filter that replaces the two (2) individuals filters (as will be shown herein). It should also be noted that although a “dual” outlet inflator is shown, either of the filters (and corresponding outlet holes) could be eliminated to make it a “single outlet” inflator, without comprising the scope/purpose of this disclosure.

As can be seen in FIG. 3, the filter 150 has an inside edge 170 and an outside edge 174. Similarly, the filter 150a has an inside edge 170 and an outside edge 174. The filters 150, 150a shown in FIG. 2A are illustrated in their fully expanded, unwrapped configuration. However, the filters 150, 150a are designed such that they may be “wrapped” filters. This means that the filters 150, 150a may be wrapped around a mandrel axis 180 to produce the round, wrapped configuration illustrated in FIG. 2. Those skilled in the art may appreciate how such “wrapping” of the filters 150, 150a may be accomplished. Of course, the illustration of the filters 150, 150a in their fully expanded, unwrapped configuration, as shown in FIG. 3, is made for clarity so that one or more of the features of the filters 150, 150a may be illustrated.

As can been seen in FIG. 3, the filters 150, 150a are tapered from the outer edge 174 to the inner edge 170. The tapering of the filters 150, 150a means that the lateral length 184 of the inner edge 170 is less than the lateral length 188 of the outer edge 174. In some embodiments, the tapering of the filters 150, 150a is designed such that the lateral length of the filter gradually decreases from the outer edge 174 to the inner edge 170. In the embodiment of FIG. 3, only a portion of the filters 150, 150a are tapered from the outer edge 740 to the inner edge 170, which means that there is a body portion 190 of the filter 150, 150a that has the same lateral length as the lateral length 188 of the outer edge 174. This body portion 190 is positioned between the outer edge 174 and the inner edge 170.

The filters 150, 150a may also be designed such that a cutout 200 is added proximate to the outer edge 174. The cutout 200 is an incision, slot, opening, hole, or notch in the filter 150, 150a that extends inwardly from the outer edge 174. In other embodiments, the cutout 200 is added to the outer edge 174. The cutout 200 is positioned such that when the filters 150, 150a are wrapped and positioned on the inflator 100 (of FIG. 2), the position of the cutout 200 corresponds to the position of the openings 124. In other words, the cutout 200 will be positioned directly inward of the exit hole 128.

Referring both to FIG. 2 and FIG. 3, the effect of the cutout 200 will now be described in greater detail. By positioning the cutout 200 directly inward of the opening 124, a plenum 206 is created between the hole 128 and the filter 150, 150a. This plenum 206 receives the inflation gas that is produced during ignition of the gas generant 104. The existence of this plenum 206 allows the escaping inflation gas to exit the exit hole 128 more freely than if the filters 150, 150a were pressed up tightly against the exit hole 128. The existence of the plenum 206 also results in reducing the internal combustion pressure of the inflator 100 during deployment.

FIGS. 2 and 3 also show some of the advantages of using the tapered filters 150, 150a. By having the tapered shape and being wrapped or wound, the filters 150, 150a are biased to expand and inherently push themselves tightly against the inner edge 210 of the chamber 108 when the inflator 100 is pressurized, thereby ensuring that the exiting inflation gases must pass through the filters 150, 150a. In some designs that do not include a tapered filter, the filters may not be pressed tightly against the chamber such that it is possible for the exiting gases to bypass the filters and go directly out the exit holes. This is especially true for filters that were not press fit against the chamber or did not have a precise, round shape. (Of course, this precise, round shape may be difficult to repeatably accomplish during production or mass production). However, such problems are eliminated by the use of the wrapped, tapered filter. The fact that the tapered filter pushes itself tightly against the inner edge 210 of the chamber 108 ensures that the gas must pass through the filters 150, 150a and cannot bypass the filters 150, 150a.

The use of the tapered filters 150, 150a may additionally provide a reduction in the internal pressure of the inflator 100 during deployment. In some other dual outlet inflator systems, the gas produced by ignition of the tightly packed gas generant must contact and go around generant pieces as it exits the chamber, thereby resulting in erosive burning of the generant and increasing the internal pressure of the inflator. In some situations, this problem is further compounded in that the produced inflation gas must travel long distances before exiting the inflator. However, with the use of the wrapped, tapered filters 150, 150a, these problems are resolved or mitigated. As shown in FIG. 2, the inflation gas still contacts and flows through the tightly packed generant bed, but only up to where the filters 150, 1 50a begin. When the gas enters the filters 150, 150a, it can more easily escape to the exit hole 128, and will no longer contact the generant. (The flow of gas through the inflator is shown via arrows 207.) This results in a reduction or elimination of erosive burning, reduces the amount of generant in the gas flow path and lowers the internal pressure of the inflator 100 during deployment to an appropriate, acceptable level. At the same time, the volume of the filters 150, 150a is not drastically increased, yet the cooling effect of the filters 150, 150a on the gas is increased. Accordingly, the inflator 100 can be longer and still not have excessive internal pressure or excessive resistance to the flow of the gas.

FIG. 4 is a plan view that illustrates another embodiment of a filter 250 that may be used in the inflator 100 of FIG. 2. Like the filters discussed above, the filter 250 is shown in FIG. 4 in its unwrapped configuration. The filter 250 may be used as either the filter 150 or the second filter 150a in the inflator 100. Those of skill in the art will appreciate how the filter 250 may replace or be used in conjunction with the filters 150, 150a.

The filter 250 is also a tapered filter. However, the filter 250 differs from that which is shown above in that the filter 250 has a non-straight taper having a stepped profile. Rather, than having the filter 250 taper gradually from the outer edge 174 to the inner edge 170, the filter 250 comprises a variety of steps 255 that “descend” from the outer edge 174 to the inner edge 170. This stepped profile may accomplish similar objectives and may provide similar results as the filters 150, 150a described above. Thus, a skilled artisan may choose to have one or more of the filters used in the inflator 100 be the stepped filter 250 or some other non-straight tapered profile (such as wavy, jagged, etc.), depending upon the particular embodiment.

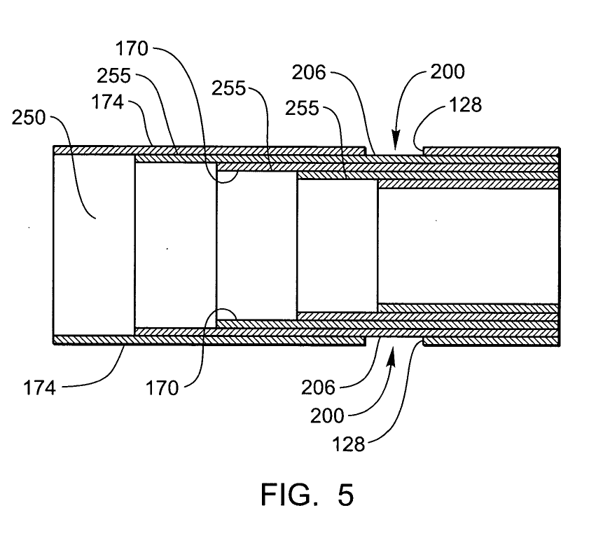

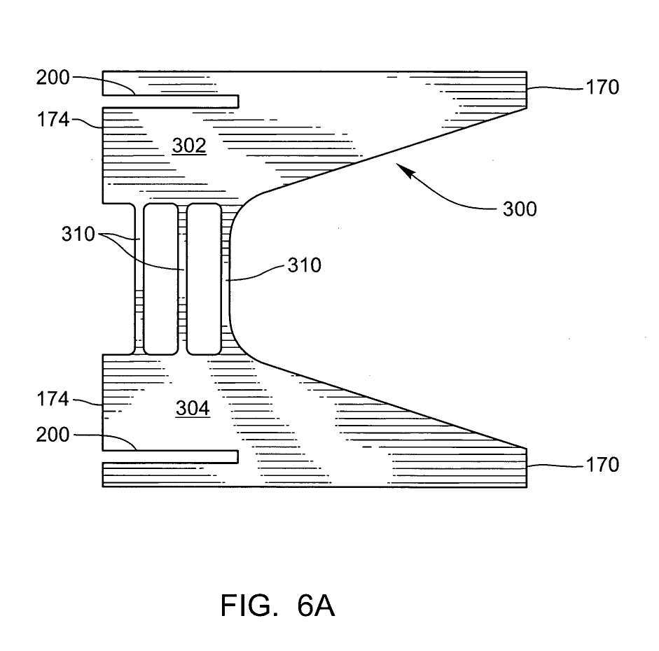

FIG. 5 is a cross-sectional view that illustrates the filter 250 in its wrapped configuration when it is positioned as part of the inflator 100. As can be seen in FIG. 5, the outer edge 174 is straight, but the inner diameter is stepped. A cutout 200 may also be added to the outer edge 174, thereby forming the plenum 206 proximate the exit holes 128.

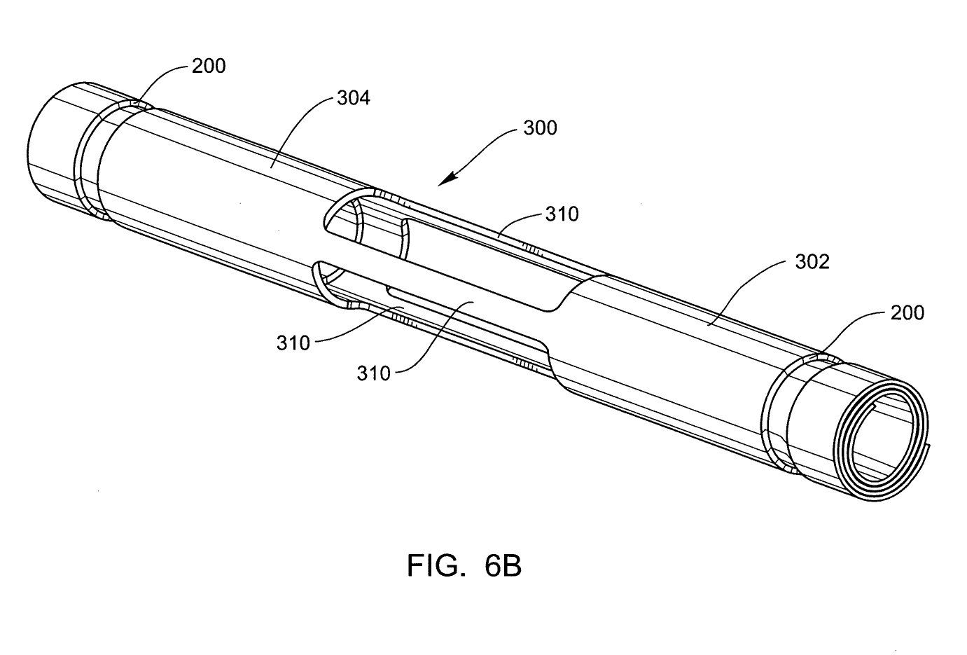

FIGS. 6A and 6B will now be described. FIGS. 6A and 6B refer to a filter 300 that may be used in the present embodiments. FIG. 6B is the wrapped view whereas FIG. 6A is the unwrapped view. The filter 300 is similar to the filters described above. Accordingly, the filter 300 may be used in an inflator 100 (shown in FIG. 2) and may be positioned proximate a generant chamber 108 (shown in FIG. 2). The filter 300 may also include an outer edge 174 and an inside or inner edge 170. The filter 300 may be tapered from the inner edge 170 to the outer edge 174.

However, the filter 300 may include two separate filter portions 302, 304 that are connected together by one or more legs 310. The filter portions 302, 304 may be wrapped in the manner described above. In fact, the filter portions 302, 304 may be similar and/or identical to the filters discussed and shown above in FIGS. 1-5 (including the cutout portions 200, etc.). The filter 300 may fit within an inflator such that the gas generant and igniter are positioned interior of the legs 310, as will be appreciated by those skilled in the art.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An inflator comprising:
a generant chamber housing a quantity of gas generant; and
a wrapped filter positioned proximate the generant chamber, the filter comprising an outer edge and an inner edge, the filter being tapered from the outer edge to the inner edge.

2. An inflator as in claim 1 further comprising a cutout proximate the outer edge.

3. An inflator as in claim 2 further comprising one or more exit holes positioned in the inflator exterior of the filter such that the cutout is aligned with the exit holes.

4. An inflator as in claim 3 wherein the cutout creates a plenum proximate the exit holes.

5. An inflator as in claim 1 wherein the filter has a non-straight, tapered profile.

6. An inflator as in claim 5 wherein the filter has a stepped profile.

7. An inflator as in claim 1 further comprising a second filter, the second filter comprising an outer edge and an inner edge, the second filter being tapered from the outer edge to the inner edge.

8. An inflator as in claim 7 further comprising a cutout proximate the outer edge of the second filter.

9. An inflator as in claim 1 further comprising an igniter tube that is at least partially positioned within the generant chamber.

10. An inflator as in claim 1 wherein only a portion of the filter is tapered from the outer edge to the inner edge.

11. An inflator as in claim 1 wherein the wrapped filter comprises two filter portions that are connected by one or more legs.
